(19) United States
(12) Patent Application Publication
(10) Pub. No.: US 2026/0038391 A1
(43) Pub. Date: Feb. 5, 2026

(54) Graft Simulant for Wound Care Training without Biological Matter

(71) Applicant: Techline Technologies, Inc., Willow Grove, PA (US)

(72) Inventors: Daniel J. Parry, Perkasie, PA (US); Joanne B. Kelly, Hatboro, PA (US)

(21) Appl. No.: 19/129,334

(22) PCT Filed: Aug. 1, 2024
(86) PCT No.: PCT/US2024/040484

§ 371 Date: Sep. 25, 2025

(51) Int. Cl. G09B 23/30

(52) U.S. Cl. CPC G09B 23/30

(57) ABSTRACT

A non-biological graft simulant for use with a non-biological wound replica in place of a cadaver or a live patient during wound care training is presented. The graft simulant includes a substrate and an outer layer. The outer layer is formed by a saline solution and a mixture of a flowable liquid including polyvinyl acetate and/or polyvinyl alcohol, a water, and a carbonate or a borate. The substrate and the outer layer imitate flexibility of a biological graft. The outer layer imitates lubricity of a biological graft. The graft simulant is made by forming the mixture, immersing the substrate into the mixture, removing the substrate from the mixture, applying the saline solution to the mixture, and firming the mixture to the substrate via the saline solution. The graft simulant is used by placing the graft simulant onto the wound replica and sliding the graft simulant to position the graft simulant.

### REFERENCE TO RELATED APPLICATIONS

This application is a National Phase of PCT Application No. PCT/US2024/040484 filed Aug. 1, 2024 entitled Graft Simulant for Wound Care Training without Biological Matter which is hereby incorporated herein in its entirety by reference thereto.

### FEDERALLY SPONSORED RESEARCH AND DEVELOPMENT

None.

### FIELD OF THE INVENTION

The disclosure generally relates to a simulant, and more particularly to a graft simulant comprising non-biological components wherein the graft simulant imitates the appearance, the feel, and/or the function of a living tissue graft so as to permit wound care training without the use of biological matter.

### BACKGROUND OF THE INVENTION

Wound care involves the treatment of tissues for the purposes of eliminating and/or preventing infection and promoting healing. Treatment depends on the type of wound. Burn-type wounds and open-type wounds, non-limiting examples of the latter being an ulcer or a bedsore, often involve application of a biological graft to living tissue. Some grafts may be in the form of an allograft which comprises tissue from a human donor. Other grafts may be in the form of an autograph which comprises tissue from a patient's own body. Yet other grafts may be in the form of a xenograft which comprises tissue from a non-human species.

One example of a graft used to treat an ulcer or a bedsore is placental tissue which retains the native components including growth factor and extracellular matrix. Placental-tissue grafts, as well as umbilical-tissue grafts and other biological grafts, are subject to compliance with a variety of laws, rules, and regulations. Compliance is particularly problematic, and often unwarranted, when biological grafts are utilized for training purposes involving treatment of a non-biological simulant of a body portion or a mannequin instead of a cadaver or a live patient. The knock-on effects of compliance increase the overall cost of training primarily due to restrictions as to transport, use, and disposal of the biological-sourced graft. Furthermore, biological grafts are expensive, if for no other reasons, because they are donor-sourced tissues and they are subject to special handling.

Accordingly, what is required is a graft simulant in the form of a non-biological substitute for a biological graft which imitates the appearance, the feel, and/or the function of biological tissue in use for training purposes.

What is also required is a method of making a graft simulant in the form of a non-biological substitute for a biological graft which imitates the appearance, the feel, and/or the function of biological tissue in use for training purposes.

What is further required is a method of using a graft simulant in the form of a non-biological substitute for a biological graft which imitates the appearance, the feel, and/or the function of biological tissue in use for training purposes.

### SUMMARY OF THE INVENTION

An object of the disclosure is a graft simulant in the form of a non-biological substitute for a biological graft which imitates the appearance, the feel, and/or the function of a biological tissue in use for training purposes.

Another object of the disclosure is a method of making a graft simulant in the form of a non-biological substitute for a biological graft which imitates the appearance, the feel, and/or the function of a biological tissue in use for training purposes.

Another object of the disclosure is a method of using a graft simulant in the form of a non-biological substitute for a biological graft which imitates the appearance, the feel, and/or the function of a biological tissue in use for training purposes.

In accordance with some embodiments, the graft simulant includes a substrate and an outer layer which simulate a biological graft for use with wound care training whereby the graft simulant is applied to a wound replica along a body simulant. The outer layer includes a flowable liquid which comprises at least one of a polyvinyl acetate or a polyvinyl alcohol, a water, at least one of a carbonate or a borate, and a saline solution. The substrate and the outer layer imitate flexibility of the biological graft. The outer layer imitates lubricity of the biological graft.

In accordance with other embodiments of the graft simulant, the substrate is a fabric.

In accordance with other embodiments of the graft simulant, the fabric is mesh shaped.

In accordance with other embodiments of the graft simulant, the fabric comprises at least one of a natural material or a synthetic material.

In accordance with other embodiments of the graft simulant, the graft simulant has a plurality of openings.

In accordance with other embodiments of the graft simulant, the graft simulant is permeable.

In accordance with other embodiments of the graft simulant, the graft simulant is non-permeable.

In accordance with other embodiments of the graft simulant, the substrate is a paper.

In accordance with other embodiments of the graft simulant, the paper comprises a cotton mallow cellulose.

In accordance with other embodiments of the graft simulant, the substrate is a synthetic mesh.

In accordance with other embodiments of the graft simulant, the flowable liquid is an aqueous adhesive emulsion.

In accordance with other embodiments of the graft simulant, the carbonate is a baking soda.

In accordance with other embodiments of the graft simulant, the borate is a borax.

In accordance with other embodiments of the graft simulant, the saline solution is a contact solution.

In accordance with other embodiments of the graft simulant, the saline solution contains a boric acid.

In accordance with other embodiments of the graft simulant, the saline solution contains a sodium borate.

In accordance with other embodiments of the graft simulant, the flowable liquid is in the range from 47.67% to 49.67% by weight relative to total weight of the outer layer, the water is in the range from 47.67% to 49.67% by weight relative to total weight of the outer layer, the at least one of the carbonate or the borate is in the range from 0.33% to 2.33% by weight relative to total weight of the outer layer, and the saline solution is in the range from 0.33% to 2.33% by weight relative to total weight of the outer layer.

In accordance with other embodiments of the graft simulant, the flowable liquid is 49.47% by weight relative to total weight of the outer layer, the water is 49.47% by weight relative to total weight of the outer layer, the at least one of the carbonate or the borate is 0.53% by weight relative to total weight of the outer layer, and the saline solution is 0.53% by weight relative to total weight of the outer layer.

In accordance with other embodiments of the graft simulant, the biological graft is an umbilical tissue.

In accordance with other embodiments of the graft simulant, the biological graft is a placental tissue.

In accordance with some embodiments of a method of making, the method includes forming a mixture including a flowable liquid, a water, and at least one of a carbonate or a borate, immersing a substrate into the mixture, removing the substrate from the mixture, applying a saline solution to the mixture, and firming the mixture via the saline solution to form the outer layer on the substrate. The flowable liquid comprises at least one of a polyvinyl acetate or a polyvinyl alcohol. The substrate is at least one of a fabric or a paper.

In accordance with other embodiments of the method of making, the mixture saturates the substrate before the applying step.

In accordance with other embodiments of the method of making, the mixture covers the substrate before the applying step.

In accordance with other embodiments of the method of making, the saline solution is sprayed onto the mixture in the applying step.

In accordance with other embodiments of the method of making, the substrate with the mixture thereon is supported on a surface in the applying step when the saline solution is sprayed onto the mixture.

In accordance with other embodiments of the method of making, the method includes working the mixture into the substrate.

In accordance with other embodiments of the method of making, the method includes working the mixture onto the substrate.

In accordance with other embodiments of the method of making, the method includes scuffing the substrate so that the mixture adheres to the substrate.

In accordance with other embodiments of the method of making, the scuffed substrate is at least in part paper.

In accordance with other embodiments of the method of making, an outer surface of the substrate is roughened via an abrasive element.

In accordance with other embodiments of the method of making, the substrate and the outer layer imitate flexibility of the biological graft after the firming step.

In accordance with other embodiments of the method of making, the outer layer imitates lubricity of the biological graft after the firming step.

In accordance with other embodiments of the method of making, the method includes drying the graft simulant after the firming step.

In accordance with other embodiments of the method of making, the method includes packaging the graft simulant after the drying step.

In accordance with other embodiments of the method of making, the method includes packaging the graft simulant after the firming step.

In accordance with other embodiments of the method of making, the method includes cooling the graft simulant after the firming step.

In accordance with other embodiments of the method of making, the method includes wetting the graft simulant in use before applied to the wound replica along the body simulant.

In accordance with other embodiments of the method of making, the biological graft is a placental tissue.

In accordance with other embodiments of the method of making, the biological graft is an umbilical tissue.

In accordance with some embodiments of a method of use, the method includes placing a graft simulant onto a surface of a wound replica along a body simulant and sliding the graft simulant along the surface to properly position the graft simulant with respect to the wound replica. The substrate comprises at least one of a fabric or a paper. The outer layer is formed by a flowable liquid, a water, at least one of a carbonate or a borate, and a saline solution. The flowable liquid comprises at least one of a polyvinyl acetate or a polyvinyl alcohol. The substrate and the outer layer imitate flexibility of the biological graft. The outer layer imitates lubricity of the biological graft.

In accordance with other embodiments of the method of use, the method includes wetting the graft simulant before the placing step.

In accordance with other embodiments of the method of use, the method includes wetting the graft simulant during the placing step.

In accordance with other embodiments of the method of use, the method includes securing the graft simulant to the body simulant.

In accordance with other embodiments of the method of use, the method includes suturing the graft simulant to the body simulant.

In accordance with other embodiments of the method of use, the method includes adhering the graft simulant to the body simulant.

In accordance with other embodiments of the method of use, the biological graft is a placental tissue.

In accordance with other embodiments of the method of use, the biological graft is an umbilical tissue.

In accordance with other embodiments of the method of use, the wound replica imitates a sore.

In accordance with other embodiments of the method of use, the wound replica imitates a burn.

In accordance with other embodiments of the method of use, the graft simulant when dry imitates appearance of the biological tissue.

In accordance with other embodiments of the method of use, the graft simulant when wet imitates appearance of the biological tissue.

In accordance with other embodiments of the method of use, the graft simulant when dry imitates feel of the biological tissue.

In accordance with other embodiments of the method of use, the graft simulant when wet imitates feel of the biological tissue.

In accordance with other embodiments of the method of use, the graft simulant when dry imitates function of the biological tissue.

In accordance with other embodiments of the method of use, the graft simulant when wet imitates function of the biological tissue.

One or more advantages may be offered by at least one embodiment of the disclosure in addition to or instead of other advantage(s) either explicitly or implicitly provided herein. In one aspect, the disclosure visually imitates the dimensions, the shape, the color, the transparency, and/or the opacity of a biological tissue graft before and/or during use. In another aspect, the disclosure imitates the sensation of a biological tissue graft when touched before and/or during use. In yet another aspect, the disclosure imitates the pliability, the rigidity, the elasticity, the non-elasticity, the slipperiness, the stickiness, the temperature, and/or the temperature conduction of a biological tissue graft before and/or during use. In still another aspect, the disclosure imitates the adherability, the movability, the coverability, the securability, the fragility, and/or the lubricity of a biological tissue graft before and/or during use.

The above and other objectives, features, and advantages of the present disclosure will become better understood from the following description, appended claims, and accompanying drawings, in which like reference numerals designate the same or similar elements.

### BRIEF DESCRIPTION OF THE DRAWINGS

Additional aspects, features, and advantages of the disclosure will be understood and will become more readily apparent when the disclosure is considered in light of the following description made in conjunction with the accompanying drawings.

FIG. 1a is a plan view illustrating a graft simulant including a substrate and an outer layer which simulate a biological graft for wound care training wherein the outer layer covers the substrate so that the graft simulant includes openings in accordance with an embodiment of the disclosure.

FIG. 1b is an enlarged view of FIG. 1a illustrating the openings through the graft simulant wherein the outer layer covers the substrate in the form of a mesh in accordance with an embodiment of the disclosure.

FIG. 1c is an enlarged cross section view of FIG. 1b illustrating the outer layer covering the substrate about an opening through the substrate in accordance with an embodiment of the disclosure.

FIG. 2a is a top plan view illustrating a graft simulant including a substrate and an outer layer which simulate a biological graft for wound care training wherein the outer layer covers the substrate in accordance with an embodiment of the disclosure.

FIG. 2b is an enlarged view of FIG. 2a illustrating the substrate in the form of a mesh concealed within the outer layer of the graft simulant in accordance with an embodiment of the disclosure.

FIG. 2c is an enlarged cross section view of FIG. 2b illustrating the outer layer covering the substrate in accordance with an embodiment of the disclosure.

FIG. 3a is a top plan view illustrating a graft simulant including a substrate and an outer layer which simulates a biological graft for wound care training wherein the outer layer covers the substrate in accordance with an embodiment of the disclosure.

FIG. 3b is an enlarged cross section view of FIG. 3a illustrating the outer layer covering the substrate in accordance with an embodiment of the disclosure.

FIG. 4 is a top plan view illustrating a graft simulant including a substrate and an outer layer which simulate a biological graft for wound care training wherein the graft simulant includes openings therethrough in accordance with an embodiment of the disclosure.

FIG. 5 is a cross section view illustrating a graft simulant including a substrate and an outer layer which simulate a biological graft for wound care training whereby the graft simulant is applied to a wound replica along a body simulant in accordance with an embodiment of the disclosure.

### DETAILED DESCRIPTION

Reference will now be made in detail to several embodiments of the disclosure that are illustrated in the accompanying drawings. Wherever possible, same or similar reference numerals are used in the drawings and the description to refer to the same or like parts.

While features of various embodiments are separately described herein, it is understood that such features may be combinable to support other additional embodiments.

The drawing figures are not necessarily drawn to scale, but instead are drawn to provide a better understanding of the components thereof, and are not intended to be limiting in scope, but to provide exemplary illustrations.

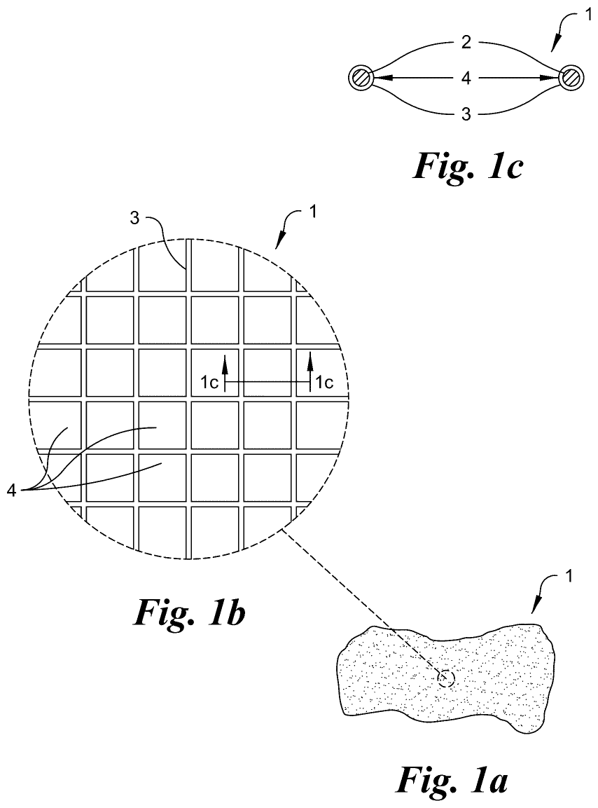

Referring now to FIGS. 1a-4, the graft simulants 1 are broadly understood to be coverings which imitate one or more of the appearance, the feel, and/or the function of a soft tissue adapted for use as a biological graft with living tissue of a patient for the purpose of wound care. The biological graft imitated by the non-biological graft simulant 1 is a living tissue, examples including but not limited to an umbilical tissue or a placental tissue.

The graft simulant 1 is sheet shaped or generally planar wherein the length and the width dimensionally exceed the thickness of the graft simulant 1. The graft simulant 1 may have any regular shape, examples including but not limited to a polygon, a circle or an ellipse, or any irregular shape, examples including but not limited to a perimeter formed by linear and/or non-linear segments. The graft simulant 1 may be porous, non-porous, permeable, or non-permeable.

In preferred embodiments, the graft simulant 1 includes both a substrate 2 and an outer layer 3 adapted to imitate at least one layer of a biological tissue. In alternate embodiments, the graft simulant 1 may include only an outer layer 3 adapted to imitate at least one layer of a biological tissue. In other alternate embodiments, the graft simulant 1 may include only a substrate 2 adapted to imitate at least one layer of a biological tissue. The graft simulant 1, in its various embodiments, imitates the appearance, the feel, and/or the function of the biological tissue graft for which the graft simulant 1 is adapted.

Wound care may include any treatment wherein a soft tissue is applied to living tissues for the purpose of eliminating infection, preventing infection, promoting healing, and/or other beneficial use to a patient. Wounds may include any compromised, injured, diseased, or otherwise damaged tissue, examples including but not limited to a burn or a sore, non-limiting examples of the latter being a bedsore or an ulcer. The non-biological graft simulant 1, in use, may be applied to a wound along a cadaver or a live patient; however, preferred uses have the non-biological graft simulant 1 applied to a non-biological simulant of a wound.

Referring now to FIGS. 1a-1c, the graft simulant 1 in some embodiments may include a substrate 2 covered in part or whole by an outer layer 3 wherein the substrate 2 and the outer layer 3 cooperate to form a plurality of openings 4. The cross section of a portion of the substrate 2 may be round as illustrated in FIG. 1c or other suitable regular or irregular shape which is uniform or non-uniform along the substrate 2. The outer layer 3 is preferred to enclose the cross section of the substrate 2. The openings 4 may be any suitable shape and arranged in any suitable pattern. In one example, the openings 4 may be uniformly shaped and patterned as illustrated by the non-limiting design in FIG. 1b. In another example, the openings 4 may be randomly shaped and patterned as illustrated by the non-limiting design in FIG. 4. In yet other embodiments, the openings 4 may be uniformly shaped and randomly patterned. In still other embodiments, the openings 4 may be randomly shaped and uniformly patterned.

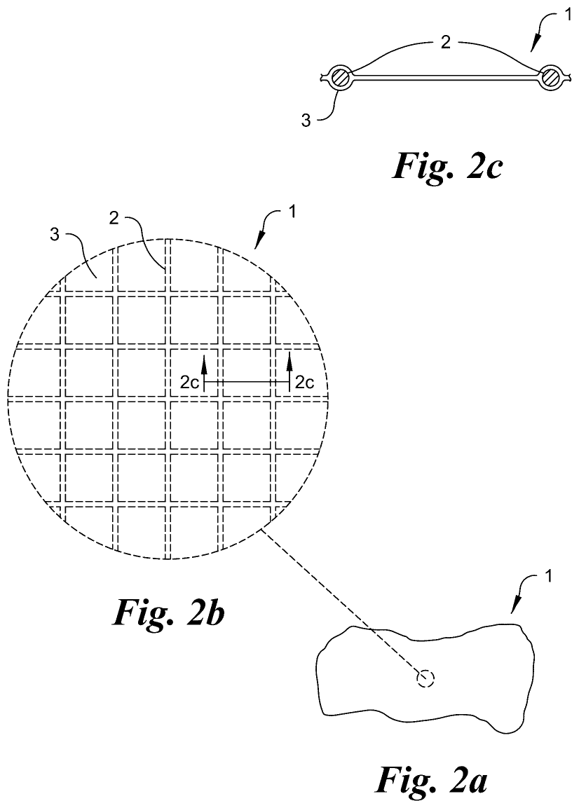

Referring now to FIGS. 2a-2c, the graft simulant 1 in some embodiments may include a substrate 2 covered in part or whole by an outer layer 3 so that the substrate 2 and the outer layer 3 in combination do not include openings 4 even though the substrate 2 alone does include openings 4. The cross section of a portion of the substrate 2 may be round as illustrated in FIG. 2c or other suitable regular or irregular shape which is uniform or non-uniform along the substrate 2. The outer layer 3 is preferred to enclose the cross section of the substrate 2. The outer layer 3 forms a connective webbing or structure, as illustrated by the non-limiting design in FIG. 2c, which fills the spaces, that is the openings 4, between adjacent portions of the substrate 2. The substrate 2 may be disposed within the outer layer 3 in any suitable shape and arranged within the outer layer 3 in any suitable pattern. In one example, the substrate 2 may be disposed within the outer layer 3 so as to be uniformly shaped and patterned as illustrated by the non-limiting design in FIG. 2b. In another example, the substrate 2 may be disposed within the outer layer 3 so as to be randomly shaped and patterned. In yet other embodiments, the substrate 2 may be disposed within the outer layer 3 so as to be uniformly shaped and randomly patterned. In still other embodiments, the substrate 2 may be disposed within the outer layer 3 so as to be randomly shaped and uniformly patterned.

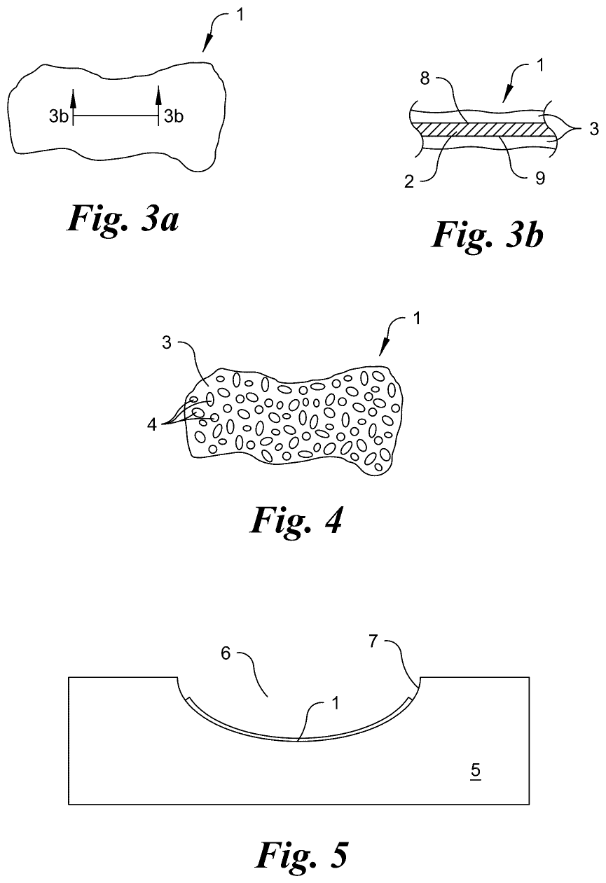

Referring now to FIGS. 3a and 3b, the graft simulant 1 in some embodiments may include a substrate 2 covered in part or whole by an outer layer 3 wherein the substrate 2 and the outer layer 3 in combination do not include openings 4. The cross section of a portion of the substrate 2 may be sheet shaped or generally planar, a non-limiting example illustrated in FIG. 3b. The outer layer 3 covers the outer surfaces 8, 9 of the substrate 2, preferably enclosing the cross section of the substrate 2. The substrate 2 may be disposed within the outer layer 3 in any suitable shape, preferably continuous therethrough.

The substrate 2 may include one or more materials either flexible or capable of being flexible when exposed to a liquid. The substrate 2 may be non-permeable or permeable. In some embodiments, the substrate 2 may or may not include openings 4 in the form of large and/or small pore-like holes. In preferred embodiments, the substrate 2 is a fabric, a paper, or a composition of fabric and paper.

The fabric may include a nature material(s) and/or a synthetic material(s). Non-limiting examples of natural materials include cotton, wool, or hemp. Non-limiting examples of synthetic materials include nylon, polyester, or rayon. The fabric may be woven, non-woven, knitted, or other suitable form. In preferred embodiments, the fabric is mesh shaped wherein non-limiting examples include a fishnet stocking or a fabric stabilizer. A fishnet stocking was found to be suitable for embodiments wherein the graft simulant 1 imitates a cryopreserved umbilical tissue. A fabric stabilizer was found to be suitable for embodiments wherein the graft simulant 1 imitates a lyopreserved umbilical tissue.

The paper may include a natural material(s) and/or a synthetic material(s). In preferred embodiments, the paper is a cellulose-based composition. An Asiatic cotton mallow cellulose paper was found to be suitable for embodiments wherein the graft simulant 1 imitates a lyopreserved placental membrane.

In some preferred embodiments, the graft simulant 1 includes a substrate 2 without an outer layer 3 wherein the substrate 2 includes a paper in part or whole, one non-limiting example being an Asiatic cotton mallow cellulose paper. In other preferred embodiments, the substrate 2 may be a rice paper with or without an outer layer 3. For embodiments not including an outer layer 3, the substrate 2 imitates the appearance, the feel, and/or the function of a biological tissue. In one non-limiting example, the graft simulant 1, when not including an outer layer 3 and at least one of dry or wet, may imitate the flexibility and/or the lubricity of a biological tissue.

The outer layer 3 is understood to include compositions either flexible or capable of being flexible when exposed to a liquid. In some embodiments, the outer layer 3 may be a non-Newtonian fluid including a polymer, one non-limiting example being a composition referred to as slime. In preferred embodiments, the outer layer 3 is a polymer-based composition which imitates the lubricity of a biological graft and which imitates the flexibility of a biological graft when used with a substrate 2 or without a substrate 2. The outer layer 3 may be non-porous, porous, non-permeable or permeable.

In preferred embodiments, the outer layer 3 includes a combination of a flowable liquid, a water, a carbonate and/or a borate, and a saline solution. The weight fraction of each constituent relative to the total weight of the outer layer 3 is application dependent and may allow for one or more formulations suitable for a particular application.

In some embodiments, the flowable liquid may include at least one suitable polymer wherein some forms of the flowable liquid include an emulsion, one non-limiting example of the latter being an aqueous adhesive emulsion. In other embodiments, the flowable liquid may include a crosslink-able polymer within an evaporative liquid, examples including but not limited to a polyvinyl acetate or a polyvinyl alcohol. In yet other embodiments, the flowable liquid may be in the form of an adhesive, one preferred embodiment being the non-toxic, multi-purpose glue sold under the trademark ELMER'S by the Newell Operating Company.

The carbonate, the borate, and/or other suitable constituent(s) facilitates formation of the outer layer 3. The carbonate may be sodium carbonate, preferably in the form of baking soda. The borate may be at least one of a sodium borate, a sodium tetraborate, or a disodium tetraborate, preferably in the form of a borax. The borax may or may not be formulated for use as a cleaning agent or a laundry detergent.

The saline solution is responsible at least in part for firming the mixture, that is making the mixture and thereby the outer layer 3 less soft and/or less flowable. In some embodiments, the saline solution may be in the form of a contact solution, preferably solutions containing at least one of a boric acid or a sodium borate. The saline solution may adjust the firmness of the outer layer 3, preferably cooperating with the carbonate and/or the borate when doing so. Other embodiments may achieve proper firmness of the outer layer 3 by formulations without water and/or by formulations without a carbonate, a borate, and/or a saline solution. Yet other embodiments may achieve proper firmness of the outer layer 3 by formulations wherein starch, preferably in liquid form, or other suitable material capable of firming the mixture is substituted for at least one of the carbonate, the borate, or the saline solution

In at least some forms of the preferred embodiments, the polymer of the flowable liquid, and specifically of the polyvinyl acetate, the polyvinyl alcohol or other crosslink-able polymer, resides within the flowable liquid in the form of molecular chains. The addition of the borate, the carbonate, and/or the saline solution to the flowable liquid allows formation of hydrogen bonds with the oxygen present in the formulation whereby the positive charge of the hydrogen atoms attracts the negative charge of the oxygen atoms. These hydrogen bonds link the molecular chains to one another so that the outer layer 3 is a low-friction, flexible mass. The hydrogen bonds are weak, and therefore breakable and reformable as the outer layer 3 is formed about the substrate 2. The composition of the outer layer 3 is firmed in part or whole to secure the outer layer 3 to the substrate 2.

The outer layer 3 is formed by preferred formulations wherein the flowable liquid is 47.67% to 49.67% by weight, the water is 47.67% to 49.67% by weight, the carbonate and/or the borate is 0.33% to 2.33% by weight, and the saline solution is 0.33% to 2.33% by weight. Each weight fraction is relative to the total weight of the outer layer 3.

The outer layer 3 is formed by a most preferred formulation wherein the flowable liquid is 49.47% by weight, the water is 49.47% by weight, the carbonate and/or the borate is 0.53% by weight, and the saline solution is 0.53% by weight. Each weight fraction is relative to the total weight of the outer layer 3.

The constituents of the outer layer 3 are combined to form a mixture. The mixture may undergo a process, a reaction, a change, a transformation, or an alternation which allows the outer layer 3 to be secured to the substrate 2. The resultant structure formed after combination of the substrate 2 and the outer layer 3 permits the non-biological graft simulant 1 to imitate the flexibility of a biological graft in preferred embodiments. Furthermore, the resultant structure permits the non-biological graft simulant 1 to imitate the lubricity of the biological graft, at least when exposed to a liquid, in preferred embodiments.

The mixture is made in a forming step by combining the constituents and then evenly distributing the constituents throughout the mixture, the latter by stirring or other suitable means. In some embodiments, the constituents may include the flowable liquid, the water, and the carbonate and/or the borate. The flowable liquid may further include the polyvinyl acetate and/or the polyvinyl alcohol and/or other suitable constituent(s). In other embodiments, the mixture may include a substitute(s), an addition(s), and/or a deletion(s) for one or more constitutes.

The substrate 2 in part or whole contacts the mixture in an immersing step. In some embodiments, the mixture may saturate the substrate 2. In other embodiments, the mixture may cover the substrate 2. In preferred embodiment, the mixture at least one of saturates or covers the substrate 2 before application of another suitable constituent(s), if any, to the mixture.

The substrate 2 is separated from the mixture in a removing step. The removing step ensures that the mixture saturating or covering the substrate 2 remains thereon. In some embodiments, the removing step maintains the pores or the holes, that is the openings 4, through the substrate 2 so that the openings 4 are part of the resultant graft simulant 1. In other embodiments, the removing step does not maintain the openings 4 through the substrate so that the resultant graft simulant 1 has no openings 4. Whether the graft simulant 1 in final form does or does not have the openings 4 of the substrate 2 is determined at least in part by the size of the openings 4 through the substrate 2, the constituents of the mixture, the weight fractions of the constituents, and/or the properties of the mixture, one non-limiting example of the latter being viscosity.

The saline solution contacts the mixture in an applying step. In some embodiments, the applying step is optional if the carbonate and/or the borate with or without another constituent(s) is/are sufficient to properly firm the mixture and to secure the mixture to the substrate 2. In preferred embodiments, the saline solution is sprayed onto the mixture to ensure application of the saline solution to the exposed surface area of the mixture. In other embodiments, the substrate 2 with mixture thereon may be supported on a surface so that the saline solution as applied is received by the upward facing side. These embodiments often require the substrate 2 with mixture thereon to be flipped after application of the saline solution to one side so that the saline solution may be applied to and received by the other side. In yet other embodiments, the mixture is worked into or onto the substrate 2 to ensure saturation and/or covering of the substrate 2 by the mixture. The mixture may be worked by rubbing kneading, pressing, folding, and/or stretching the substrate 2 and/or mixture thereon. These embodiments may require the mixture to be worked during the immersing step and/or the applying step, that is before the mixture is properly firmed.

In some embodiments, the mixture may not properly secure to the substrate 2 because of a property of the substrate 2 and/or a property of the mixture. In one non-limiting example, the mixture may separate from the substrate 2 before the mixture is firmed. Therefore, it may be advantageous to prepare the substrate 2 before application of the mixture. In one non-limiting example, the substrate 2 may be prepared in a scuffing step to accept the mixture whereby the outer surfaces 8, 9 are roughened so that the mixture remains on the substrate 2. The scuffing step may be implemented by rubbingly contacting the outer surfaces 8, 9 by an abrasive element. Non-limiting examples of an abrasive element are a sand paper or a scouring pad. In preferred embodiments, the scuffing step is implemented before the immersing step. Although the scuffing step might be advantageous to some degree for all forms of the substrate 2, it was found to be beneficial when the substrate 2 is a paper, and more particularly a paper including cotton mallow cellulose. Furthermore, when the graft simulant 1 includes a substrate 2 only and the substrate 2 includes a paper in part or whole, one non-limiting example being a transparent Asiatic cotton mallow cellulose paper, scuffing was particularly advantageous to imitate the appearance, the feel, and/or the function of a biological tissue graft.

The mixture is firmed in the firming step via the saline solution to complete the outer layer 3 on the substrate 2. The firming step may include a change in or to the consistency, the firmness, and/or the texture of or to the mixture which stabilizes the mixture so that the mixture has the required appearance and/or feel and/or permits the required functionality. In some embodiments, the firming step is by way of the carbonate and/or the borate with or without other constituent(s) when sufficient to properly firm the mixture and to secure the mixture to the substrate 2. After the firming step, the outer layer 3 formed by the mixture remains on the substrate 2 and is an integral part of the graft simulant 1. The outer layer 3 is understood to be secured to the substrate 2 by way of, but not limited to, mechanical means and/or adherence means.

For embodiments of the graft simulant 1 without a substrate 2, the immersing step and the removing step are replaced by a molding step. The mixture is molded to form a net shape of the outer layer 3, either completely or nearly completely firmed, and thereafter the applying step and the firming step complete the outer layer 3, if nearly completely firmed.

Any liquid, an example including but not limited to water, remaining on the completed graft simulant 1 may be removed by a drying step. The drying step may be implemented by evaporating the liquid, in part or whole, at room temperature conditions or by evaporating the liquid via a heater or an oven. The drying step is advantageous to imitating graft simulants 1 sold in a lyopreserved form or a cryopreserved form, although not limited to just these forms.

In some embodiments, the graft simulant 1 may be cooled to a temperature less than room temperature to further realistically imitate the graft simulant 1. Non-limiting examples include temperatures typical of a lyopreserved process or a cryopreserved process. In preferred embodiments, the graft simulant 1 is cooled after the firming step.

The graft simulant 1 may be secured within a covering in a packaging step. The covering may replicate packaging known within the art. The packaging step may be performed after the firming step or the drying step. If after the firming step, the graft simulant 1 is often wet to at least some degree and in some embodiments may be sticky to the touch.

The graft simulant 1 may be exposed to a liquid in a wetting step. In one non-limiting example, a water may be sprayed onto the graft simulant 1. The wetting step may be advantageous when the graft simulant 1 is dry, when the graft simulant 1 is less wet than required for a particular use, or when at least one of the appearance, the feel, or the functionality of the graft simulant 1 requires adjustment. In some applications, the wetting step may be used to increase the flexibility and/or the lubricity of the graft simulant 1. Regardless, it is understood that the liquid may be applied to the graft simulant 1 via any suitable technique, process, method, procedure, equipment, or means.

Referring now to FIG. 5, the graft simulant 1, in use, contacts a wound replica 6 along a surface 7 of a body simulant 5 in a placing step. In some embodiments, the graft simulant 1 may be placed directly onto the wound replica 6 in part or whole and thereafter positionally adjusted to the proper location. In other embodiments, the graft simulant 1 may be placed onto the body simulant 5 and adjacent to the wound replica 6 and positionally adjusted to the proper location.

The graft simulant 1 may be placed onto the surface 7 of the body simulant 5, and thereafter positionally adjusted, by hand with or without use of a medical instrument. In other embodiments, the graft simulant 1 may be placed onto the surface 7 of the body simulant 5 by way of a robotic arm or a controllable appendage, and thereafter positionally adjusted, with or without use of a medical instrument. Regardless, it is understood that the graft simulant 1 may be adapted so as to be applied and/or adjusted via any suitable technique, process, method, procedure, equipment, and/or means.

In preferred embodiments, the positional adjustment to the graft simulant 1 is implemented in a sliding step whereby the graft simulant 1 is slidingly moved along the surface 7. The sliding may require application of a liquid, one non-limiting being a water, to adjust a property of the graft simulant 1. The application of a liquid to the graft simulant 1 may be implemented in a wetting step before the placing step and/or during the placing step. In some embodiments, the wetting step may improve adjustability of the graft simulant 1 by increasing the flexibility of the substrate 2 and/or the outer layer 3. In other embodiments, the wetting step may improve adjustability of the graft simulant 1 by lowering a friction characteristic of the outer layer 3. When the graft simulant 1 includes a substrate 2 only and the substrate 2 includes a paper in part or whole, one non-limiting example being a transparent Asiatic cotton mallow cellulose paper, wetting was particularly advantageous to imitate the appearance, the feel, and/or the function of a biological tissue graft. With respect to a graft simulant 1 including a substrate 2 without an outer layer 3, wetting may allow the graft simulant 1 to imitate the curling typical of a lyopreserved placental membrane. Furthermore, placing, sliding, drying, wetting, cooling, securing, suturing, adhering, and/or other means, in part or whole, described herein may be applied to a graft simulant 1 including a substrate 2 without an outer layer 3 or an outer layer 3 without a substrate 2 to imitate the appearance, the feel, and/or the function of biological tissue.

The body simulant 5 may be adapted to simulant a living body in part or whole. In preferred embodiments, the body simulant 5 is understood to be a non-biological element which simulates the appearance, the feel, and/or the function of living tissue at and adjacent to the wound replica 6. The wound replica 6 is further understood to be a non-biological feature of the body simulant 5 which simulates the appearance, the feel, and/or the function of a compromised tissue, an injured tissue, a diseased tissue, or a damaged tissue at a wound site. By way of several non-limiting examples, the wound replica 6 may imitate a sore, a burn, a penetration injury, an impact injury, a tear injury, or other condition of or to a living tissue for which treatment by or with a graft is beneficial.

The body simulant 5 and the wound replica 6 may be made of silicone, urethane, and/or other suitable material(s). The body simulant 5 and the wound replica 6 may be in the form of the non-limiting examples and/or made via the non-limiting methods or the non-limiting techniques described in U.S. Pat. No. 8,491,309 for the Wearable Wound Simulant, U.S. Pat. No. 10,115,322 for the Torso Simulant with Vascular Elements Mechanically Responsive to a Tourniquet, or U.S. patent application Ser. No. 18/413,167 for the Wound Box Trainer. Other forms, methods, and techniques known within the art are likewise applicable. It is also possible in some embodiments for the body simulant 5 to include elements which imitate a vascular element, an organ, a bone, and/or other soft or hard tissue.

Some uses during wound care training may require the graft simulant 1 to be fixed to the body simulant 5. The graft simulant 1 may be secured to the body simulant 5 to prevent relative movement between the graft simulant 1 and the body simulant 5 after the placing step or the sliding step. In some embodiments, the securing step may be implemented via any technique, process, method, procedure, or means understood in the art. In one non-limiting example, the graft simulant 1 may be fixed in part or whole to the body simulant 5 via suturing. In another non-limiting example, the graft simulant 1 may be fixed in part or whole to the body simulant 5 via adhering including use of a medical adhesive or the like. In other embodiments, the securing step may be implemented via a property, a characteristic, or a feature of the graft simulant 1 and/or the body simulant 5. In one non-limiting example, the graft simulant 1 may be fixed in part or whole to the body simulant 5 via attractive properties of the graft simulant 1, the body simulant 5, and/or a liquid applied to one of the graft simulant 1 or the body simulant 5.

The graft simulant 1 may be adapted to imitate the appearance of a biological tissue. Aspects of appearance may include, by way of several non-limiting examples, dimensions, shape, color, transparency, the smell, and/or opacity of a living tissue graft before and/or during use. In some embodiments, the appearance may be imitated when the biological tissue, that is the living tissue being imitated, is in a dry condition. However, it is understood that graft simulant 1 may be one of dry or wet in order to imitate the appearance of the dry biological tissue. In other embodiments, the appearance may be imitated when the biological tissue, that is the living tissue being imitated, is in a wet condition. However, it is understood that graft simulant 1 may be one of dry or wet in order to imitate the appearance of the wet biological tissue. The smell of a biological tissue graft may be imitated by way of a simulant, a bioidentical substitute, and/or other suitable material or means.

The graft simulant 1 may be adapted to imitate the feel, that is the tactile sensation, by a biological tissue. Aspects of tactile sensation may include, by way of several non-limiting examples, pliability, rigidity, elasticity, non-elasticity, slipperiness, stickiness, temperature, and/or temperature conduction of a living tissue graft before and/or during use. In some embodiments, the tactile sensation may be imitated when the biological tissue, that is the living tissue being imitated, is in a dry condition. However, it is understood that graft simulant 1 may be one of dry or wet in order to imitate the tactile sensation of the dry biological tissue. In other embodiments, the tactile sensation may be imitated when the biological tissue, that is the living tissue being imitated, is in a wet condition. However, it is understood that graft simulant 1 may be one of dry or wet in order to imitate the tactile sensation of the wet biological tissue.

The graft simulant 1 may be adapted to imitate the functionality by a biological tissue. Aspects of functionality may include, by way of several non-limiting examples, adherability, movability, coverability, securability, fragility, and/or lubricity of a living tissue graft before and/or during use. In some embodiments, the functionality may be imitated when the biological tissue, that is the living tissue being imitated, is in a dry condition. However, it is understood that graft simulant 1 may be one of dry or wet in order to imitate the functionality of the dry biological tissue. In other embodiments, the functionality may be imitated when the biological tissue, that is the living tissue being imitated, is in a wet condition. However, it is understood that graft simulant 1 may be one of dry or wet in order to imitate the functionality of the wet biological tissue.

While the disclosure is susceptible to various modifications and alternative constructions, certain illustrative embodiments are shown in the drawings and are described in detail herein. It should be understood, however, there is no intention to limit the disclosure to the specific embodiments disclosed, but on the contrary, the intention is to cover all modifications, alternative constructions, combinations, and equivalents falling into the spirit and scope of the disclosure.

What is claimed is:

1. A graft simulant (1) which simulates a biological graft for use with wound care training whereby said graft simulant (1) is applied to a wound replica (6) along a body simulant (5), said graft simulant (1) comprising:
(a) a substrate (2); and
(b) an outer layer (3) contacting said substrate (2);
wherein:
said outer layer (3) including:
(i) a flowable liquid comprising at least one of a polyvinyl acetate or a polyvinyl alcohol;
(ii) a water;
(iii) at least one of a carbonate or a borate; and
(iv) a saline solution;
said substrate (2) and said outer layer (3) imitate flexibility of said biological graft;
said outer layer (3) imitates lubricity of said biological graft.

2. The graft simulant (1) of claim 1, wherein said substrate (2) being a fabric.

3. The graft simulant (1) of claim 2, wherein said fabric being mesh shaped.

4. The graft simulant (1) of claim 2, wherein said fabric comprises at least one of a natural material or a synthetic material.

5. The graft simulant (1) of claim 1, wherein said graft simulant (1) has a plurality of openings (4).

6. The graft simulant (1) of claim 1, wherein said graft simulant (1) being permeable.

7. The graft simulant (1) of claim 1, wherein said graft simulant (1) being non-permeable.

8. The graft simulant (1) of claim 1, wherein said substrate (2) being a paper.

9. The graft simulant (1) of claim 8, wherein said paper comprises cotton mallow cellulose.

10. The graft simulant (1) of claim 1, wherein said substrate (2) being a synthetic mesh.

11. The graft simulant (1) of claim 1, wherein said flowable liquid being an aqueous adhesive emulsion.

12. The graft simulant (1) of claim 1, wherein said carbonate being a baking soda.

13. The graft simulant (1) of claim 1, wherein said borate being a borax.

14. The graft simulant (1) of claim 1, wherein said saline solution being a contact solution.

15. The graft simulant (1) of claim 1, wherein said saline solution containing a boric acid.

16. The graft simulant (1) of claim 1, wherein said saline solution containing a sodium borate.

17. The graft simulant (1) of claim 1, wherein said flowable liquid being in the range from 47.67% to 49.67% by weight relative to total weight of said outer layer (3), said water being in the range from 47.67% to 49.67% by weight relative to total weight of said outer layer (3), said at least one of said carbonate or said borate being in the range from 0.33% to 2.33% by weight relative to total weight of said outer layer (3), said saline solution being in the range from 0.33% to 2.33% by weight relative to total weight of said outer layer (3).

18. The graft simulant (1) of claim 1, wherein said flowable liquid being 49.47% by weight relative to total weight of said outer layer (3), said water being 49.47% by weight relative to total weight of said outer layer (3), said at least one of said carbonate or said borate being 0.53% by weight relative to total weight of said outer layer (3), said saline solution being 0.53% by weight relative to total weight of said outer layer (3).

19. The graft simulant (1) of claim 1, wherein said biological graft being an umbilical tissue.

20. The graft simulant (1) of claim 1, wherein said biological graft being a placental tissue.

21. A method of making a graft simulant (1) including a substrate (2) and an outer layer (3) which simulate a biological graft for use with wound care training whereby said graft simulant (1) is applied to a wound replica (6) along a body simulant (5) comprising the steps of:
forming a mixture including a flowable liquid, a water, and at least one of a carbonate or a borate, said flowable liquid comprising at least one of a polyvinyl acetate or a polyvinyl alcohol;
immersing said substrate (2) into said mixture, said substrate being at least one of a fabric or a paper;
removing said substrate (2) from said mixture;
applying a saline solution to said mixture; and
firming said mixture via said saline solution to form said outer layer (3) on said substrate (2).

22. The method of making said graft simulant (1) of claim 21, wherein said mixture saturates said substrate (2) before said applying step.

23. The method of making said graft simulant (1) of claim 21, wherein said mixture covers said substrate (2) before said applying step.

24. The method of making said graft simulant (1) of claim 21, wherein said saline solution being sprayed onto said mixture in said applying step.

25. The method of making said graft simulant (1) of claim 21, wherein said substrate (2) with said mixture thereon being supported on a surface in said applying step when said saline solution being sprayed onto said mixture.

26. The method of making said graft simulant (1) of claim 21, further comprising the step of:
working said mixture into said substrate (2).

27. The method of making said graft simulant (1) of claim 21, further comprising the step of:
working said mixture onto said substrate (2).

28. The method of making said graft simulant (1) of claim 21, further comprising the step of:
scuffing said substrate (2) so that said mixture adheres to said substrate (2).

29. The method of making said graft simulant (1) of claim 28, wherein said substrate (2) being at least in part said paper.

30. The method of making said graft simulant (1) of claim 28, wherein an outer surface (8, 9) of said substrate (2) being roughened via an abrasive element.

31. The method of making said graft simulant (1) of claim 21, wherein said substrate (2) and said outer layer (3) imitate flexibility of said biological graft after said firming step.

32. The method of making said graft simulant (1) of claim 21, wherein said outer layer (3) imitates lubricity of said biological graft after said firming step.

33. The method of making said graft simulant (1) of claim 21, further comprising the step of:
drying said graft simulant (1) after said firming step.

34. The method of making said graft simulant (1) of claim 33, further comprising the step of:
packaging said graft simulant (1) after said drying step.

35. The method of making said graft simulant (1) of claim 21, further comprising the step of:
packaging said graft simulant (1) after said firming step.

36. The method of making said graft simulant (1) of claim 21, further comprising the step of:
cooling said graft simulant (1) after said firming step.

37. The method of making said graft simulant (1) of claim 21, further comprising the step of:
wetting said graft simulant (1) before applied to said wound replica (6) along said body simulant (5).

38. The method of making said graft simulant (1) of claim 21, wherein said biological graft being a placental tissue.

39. The method of making said graft simulant (1) of claim 21, wherein said biological graft being an umbilical tissue.

40. A method of use for a graft simulant (1) including a substrate (2) and an outer layer (3) which simulates a biological graft for wound care training comprising the steps of:
placing said graft simulant (1) onto a surface (7) of a wound replica (6) along a body simulant (5); and
sliding said graft simulant (1) along said surface (7) to properly position said graft simulant (1) with respect to said wound replica (6);
wherein:
said substrate (2) comprises at least one of a fabric or a paper;
said outer layer (3) being formed by a flowable liquid, a water, at least one of a carbonate or a borate, and a saline solution;
said flowable liquid comprising at least one of a polyvinyl acetate or a polyvinyl alcohol;
said substrate (2) and said outer layer (3) imitate flexibility of said biological graft;
said outer layer (3) imitates lubricity of said biological graft.

41. The method of use for said graft simulant (1) of claim 40, further comprising the step of:
wetting said graft simulant (1) before said placing step.

42. The method of use for said graft simulant (1) of claim 40, further comprising the step of:
wetting said graft simulant (1) during said placing step.

43. The method of use for said graft simulant (1) of claim 40, further comprising the step of:
securing said graft simulant (1) to said body simulant (5).

44. The method of use for said graft simulant (1) of claim 40, further comprising the step of:
suturing said graft simulant (1) to said body simulant (5).

45. The method of use for said graft simulant (1) of claim 40, further comprising the step of:
adhering said graft simulant (1) to said body simulant (5).

46. The method of use for said graft simulant (1) of claim 40, wherein said biological graft being a placental tissue.

47. The method of use for said graft simulant (1) of claim 40, wherein said biological graft being an umbilical tissue.

48. The method of use for said graft simulant (1) of claim 40, wherein said wound replica (6) imitates a sore.

49. The method of use for said graft simulant (1) of claim 40, wherein said wound replica (6) imitates a burn.

50. The method of use for said graft simulant (1) of claim 40, wherein said graft simulant (1) when dry imitates appearance of said biological tissue.

51. The method of use for said graft simulant (1) of claim 40, wherein said graft simulant (1) when wet imitates appearance of said biological tissue.

52. The method of use for said graft simulant (1) of claim 40, wherein said graft simulant (1) when dry imitates feel of said biological tissue.

53. The method of use for said graft simulant (1) of claim 40, wherein said graft simulant (1) when wet imitates feel of said biological tissue.

54. The method of use for said graft simulant (1) of claim 40, wherein said graft simulant (1) when dry imitates function of said biological tissue.

55. The method of use for said graft simulant (1) of claim 40, wherein said graft simulant (1) when wet imitates function of said biological tissue.
